(19) United States
(12) Patent Application Publication
(10) Pub. No.: US 2008/0163768 A1
(43) Pub. Date: Jul. 10, 2008

(54) FOOD PROCESSOR

(76) Inventors: Dov Z. Glucksman, Danvers, MA (US); Laura J. Nickerson, Fitchburg, MA (US); David N. Belanger, Peabody, MA (US); Gary P. McGonagle, Lynn, MA (US)

Correspondence Address: Lawrence Cruz;Conair Corporation, One Cummings Point Road, STAMFORD, CT, 06902, US

(21) Appl. No.: 11/959,637

(22) Filed: Dec. 19, 2007

Related U.S. Application Data
(60) Provisional application No. 60/875,681, filed on Dec. 19, 2006.

(51) Int. Cl. A23P 1/00; B26D 7/00; B26D 1/12

(52) U.S. Cl. 99/537; 83/167; 83/663

(57) ABSTRACT

A food processor (10) includes: a blade (30) that is variously configurable by having its shape and configuration be selectively adjustable; a bowl (18) adapted to be used alone or with various sized bowl inserts (50, 60) which cooperate with the adjustable blade (30) for optimal relative sizing and performance; a variable length feed tube (304); a weighted feed tube pusher (306) for automatically pushing food through the tube (304); and a selectively actuable spatula (204); for cleaning the inside of the bowl (18).

### CROSS REFERENCE TO RELATED APPLICATIONS

This application claims the benefit of and priority to U.S. Provisional Patent Application Ser. No. 60/875,681, filed Dec. 19, 2006, the entire content of which is incorporated by reference herein.

### BACKGROUND

1. Field of the Disclosure

The present invention relates to food appliances and, more particularly, to electric food processors.

2. Description of Related Art

Electric food processors exist in various sizes and forms. A food processor may be used to prepare food by mixing, grinding, chopping, slicing, grating, shredding, or by a variety of other processing operations. A food processor typically includes a base housing an electric motor, a drive shaft driven by the motor, a bowl and a lid mounted to the bowl. A rotatably driven blade is mounted to the drive shaft to process the food product inside the bowl.

A limitation of existing food processor appliances is that they are confined to dedicated configurations of blade size and shape, bowl size and shape, and feed chute size and shape. Some are sold with interchangeable components, but, require storage space for these additional components, and, consequently, increase the overall expense of the appliance.

### SUMMARY

Accordingly, the present disclosure is directed to a food processor appliance having variously configurable blade, bowl and feed chute components. Such components are inclusive of a manually actuable spatula for cleaning the inside of the bowl without requiring removal of the lid, a selectively extendable blade mechanism for operation in different size bowls and a weighted food pusher for automatically pushing food down a chute into a rotating food processor blade.

According to one aspect of the present disclosure, a food processor includes: a mixing blade that is variously configurable by having its shape and configuration be selectively adjustable; a bowl adapted to be used alone or with various sized bowl inserts which cooperate with the adjustable blade for optimal relative sizing and performance; a variable length feed tube; a weighted feed tube pusher for automatically pushing food through the tube; and a selectively actuable spatula for cleaning the inside of the bowl.

### BRIEF DESCRIPTION OF THE DRAWINGS

Preferred embodiments of the present disclosure will be appreciated by reference to the drawings wherein:

FIG. 1 is a side plan view of a food processor in accordance with the principles of the present disclosure;

FIG. 2 is a perspective view of the main bowl or food receptacle and blade mechanism of the food processor of FIG. 1;

FIG. 3 is a top plan view of the main receptacle and blade mechanism illustrating the blades of the blade mechanism in a first radial outward position;

FIGS. 4 and 5 are perspective and side plan views respectively illustrating the blades of the blade mechanism in the first radial outward position;

FIGS. 6 and 7 are perspective and side plan views respectively illustrating the blades of the blade mechanism in the second radial inward position;

FIG. 8 is a perspective view of the main receptacle incorporating a nested second medium-sized receptacle with the blade mechanism in the first radial outward position;

FIGS. 9 and 10 are side and top plan views respectively of the main receptacle, second medium receptacle and mounted blade mechanism in the first radial outward position;

FIG. 11 is a perspective view of the main receptacle further incorporating a nested third small receptacle with the blade mechanism in the second radial inward position;

FIGS. 12 and 13 are side and top plan views respectively of the main receptacle, third small receptacle and mounted blade mechanism in the second radial inward position;

FIGS. 14 and 15 are perspective and side plan views respectively of an alternate embodiment of the blade mechanism of FIG. 4 illustrating the blades in the first radial outward position;

FIGS. 16 and 17 are perspective and side plan views respectively of the blade mechanism of FIGS. 14 and 15 illustrating the blades in the second radial inward position;

FIGS. 18A and 18B are partial cross-sectional views taken along the lines 18A-18A and 18B-18B of FIG. 14 illustrating the mechanism for moving the blades of the blade mechanism of FIGS. 14-17 between the first radial outward position and the second radial inward position;

FIG. 19 is a perspective view of an alternate embodiment of the main receptacle of the food processor of FIG. 1 incorporating a spatula mechanism;

FIG. 20 is a perspective view of the spatula mechanism of FIG. 19;

FIG. 21 is a cross-sectional view illustrating the relationships of the actuator, helical screw and planetary gear mechanism of the spatula mechanism.

FIG. 22 is a perspective view of the main receptacle of the food processor of FIG. 1 incorporating a weighted feed tube pusher; and

FIG. 23 is a perspective view similar to the view of FIG. 22 illustrating the feed tube pusher in its lowest position relative to the cover of the receptacle.

### DETAILED DESCRIPTION OF THE EMBODIMENTS

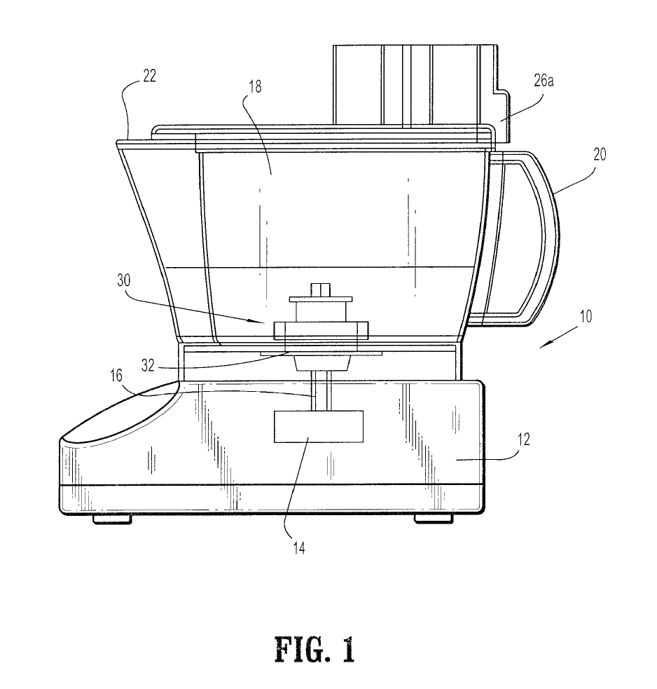

Referring now to the drawings wherein like reference numerals identify similar or like components throughout the several views, FIG. 1 illustrates a food processor appliance 10 in accordance with the principals of the present disclosure. Food processor 10 includes base 12 which houses motor 14 (depicted schematically) and having drive shaft 16 extending from the base 12 and actuated by the motor 14. Motor 14 may be controlled and manipulated by a control panel which is mounted on the front of base 12 and is in communication with circuitry or logic within the base 12 to control functioning of food processor 10 as is known in the art. One suitable base is disclosed in commonly assigned U.S. Pat. No. 7,063,283 to Wanat or commonly assigned U.S. Pat. No. 7,069,839 to Kernan, the entire contents of each disclosure being incorporated herein by reference.

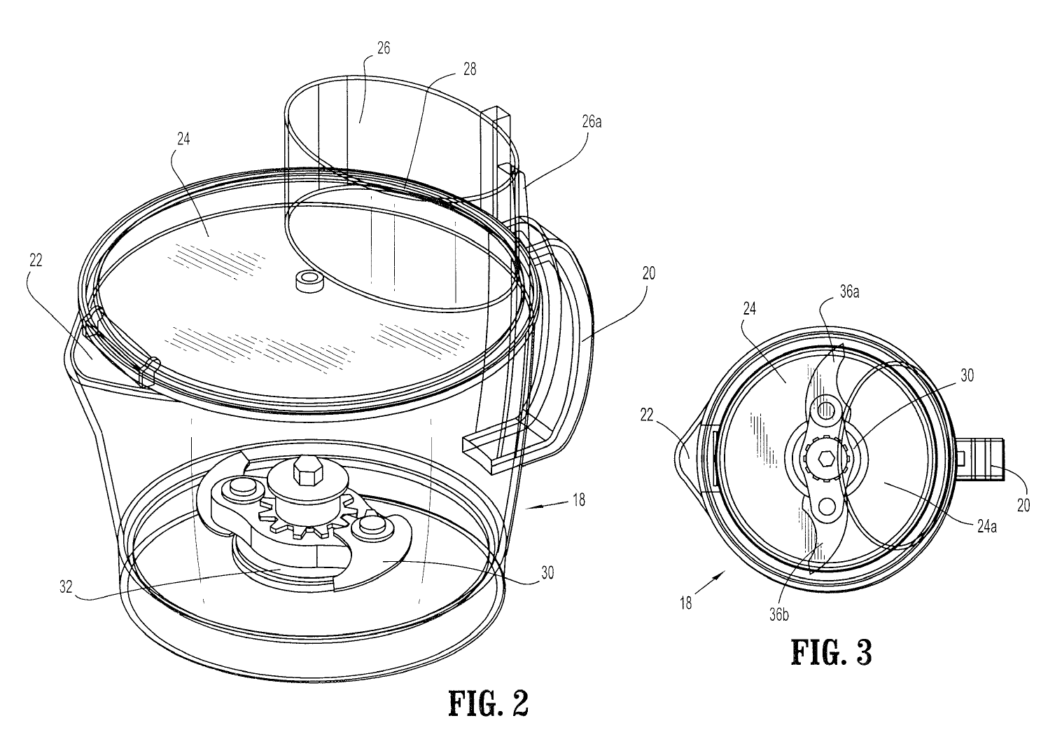

Referring now to FIGS. 2-3, in conjunction with FIG. 1, food processor 10 further includes main receptacle or bowl 18 mounted to the top of the base 12. Main receptacle 18 may include handle 20 for engagement by the user, spout 22 in opposed relation to the handle 22 for pouring liquid contents accumulated within the main receptacle 18, and lid or cover 24. Cover 24 may include food chute 26 depending from the cover 24 and having central opening 28 for depositing of food substances within main receptacle 18. Food chute 26 may be integral with cover 24 or may be independent from the cover 24 and positioned relative to the cover 24 when in use. If independent from cover 24, food chute 26 may be supported by its placement on the upper surface of the cover 24. With this arrangement, cover 24 will have opening 24a in communication with the central opening 28 of food chute 26. Food chute 26 may further incorporate depending tab 26a which may cooperate with handle 22 to fix the food chute from rotational movement relative to cover 24. In the alternative, depending tab 26a may incorporate a channel with an associated plunger which serves as a safety interlock ensuring that food chute 26 is properly positioned relative to cover 24. Safety interlock arrangement(s) are disclosed in the Kernan '839 patent.

Food processor 10 incorporates a blade mechanism, generally identified by reference numeral 30, for performing the slicing, dicing, chopping, etc. functions on the food substances. Blade mechanism 30 may be mounted about receptacle hub 32 of main receptacle 18 to operatively connect with drive shaft 16 of motor 14. Receptacle hub 32 may incorporate a shaft or the like which cooperatively engages drive shaft 16 of motor 14 as is known in the art.

With reference now to FIGS. 2-5, blade mechanism 30 will be described in detail. Blade mechanism 30 includes blade mount 34 and a pair of blades 36a, 36b operatively connected to the blade mount 34 and arranged in diametrical opposed relation as shown. Blade mount 34 incorporates central shaft 34s which cooperates with receptacle hub 32 of main receptacle 18 to operatively connect the components. Central shaft 34s may include central opening 34p having a polygonal or non-circular cross-section. In one embodiment, blade 36a is operatively connected to a lower surface of blade mount 34 through hinge or pin 38a, and blade 36b is operatively connected to the upper surface of blade mount 34 through hinge or pin 38b. Blade mechanism 30 further includes deployment member 40, upper gear or ratchet wheel 42 mounted adjacent the upper surface of blade mount 34 and lower gear 44 mounted adjacent the lower surface of the blade mount 34. Upper and lower gears 42, 44 may be identical in design. Deployment member 40 may be, for example, in the form of a rotatable control knob, and is secured or integrally connected to upper gear 42 and lower gear 44. In one embodiment, deployment member 40 may extend through blade mount 34 with upper gear 42 and lower gear 44 secured about the periphery of the deployment member 40 through conventional means such as with the use of adhesives or the like. Alternatively, deployment member 40 may incorporate keyed slots to receive the respective upper and lower gears 42, 44 in a manner to secure the gears 42, 44 to the deployment member 40. Deployment member 40 is adapted for rotational movement about mount axis “k” which causes corresponding rotational movement of upper gear 42 and lower gear 44 in the same direction. Each blade 36a, 36b incorporates at least one, preferably two, ratchet teeth 46a, 46b which cooperatively engage the respective teeth 48, 50 of upper gear and lower gear 42, 44.

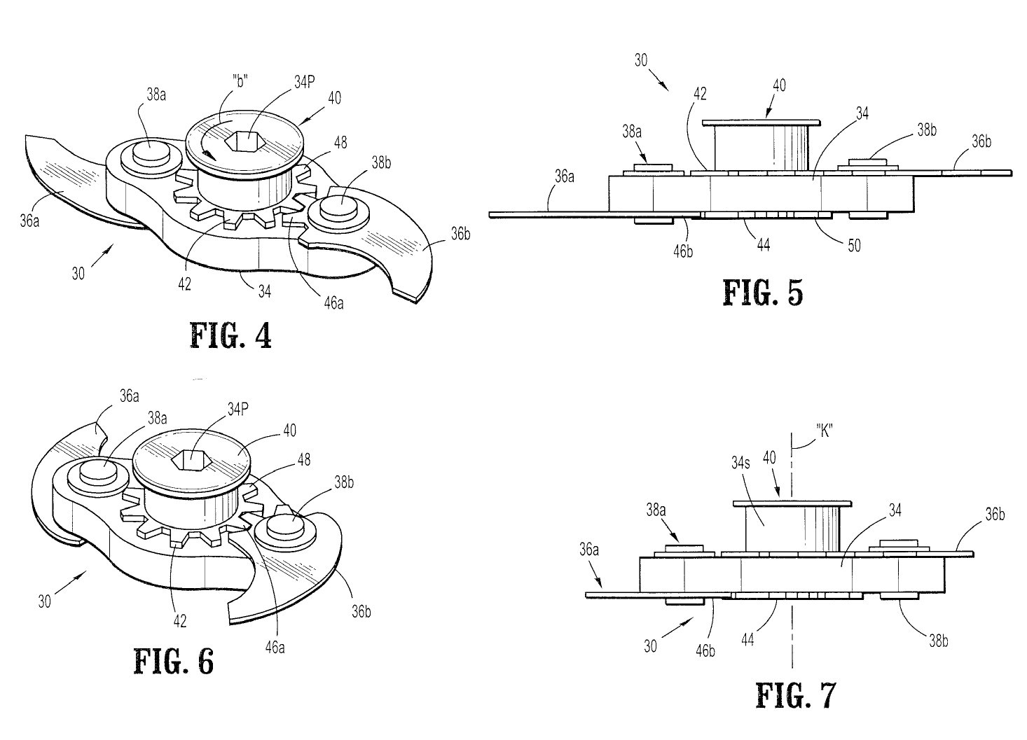

Blades 36a, 36b are adapted to rotate about their respective pivot pins 38a, 38b in response to corresponding rotational movement of deployment member 40. In one embodiment, blades 36a, 36b are adapted for rotational movement from a first extended or radial outward position depicted in FIGS. 4-5 to a second collapsed or radial inward position depicted in FIGS. 6-7 via manipulation of deployment member 40. In particular, rotation of deployment member 40 in a counterclockwise direction depicted by directional arrow “b” FIG. 4 will cause corresponding counterclockwise rotation of upper and lower gears 42, 44 whereby the respective ratchet teeth 46a, 46b of blades 36a, 36b intermesh with the teeth 48, 50 of upper and lower gears 42, 44 to move the blades 36a, 36b to the radial second inward position of FIGS. 6 and 7. Similarly, rotational movement of deployment member 40 in a clockwise direction will correspondingly drive blades 36a, 36b to the first radial outward position of FIGS. 4-5 through cooperation of the respective gears 42, 44 and ratchet teeth 46a, 46b. This feature, thus, enables the operator to selectively position blades 36a, 36b of blade mechanism 30 in the first outward or second inward positions to accommodate various sized bowls or receptacles. It is envisioned that blades 36a, 36b may be selectively arranged at relative positions between or intermediate of the first outward and second inward positions. Is further envisioned that blades 36a, 36b may be secured in any of these positions through a locking mechanism associated, e.g., with either deployment member 40, upper gear 42 and/or lower gear 44. FIGS. 2-3 illustrate blades 36a, 36b in the first radial outward position within main receptacle 18.

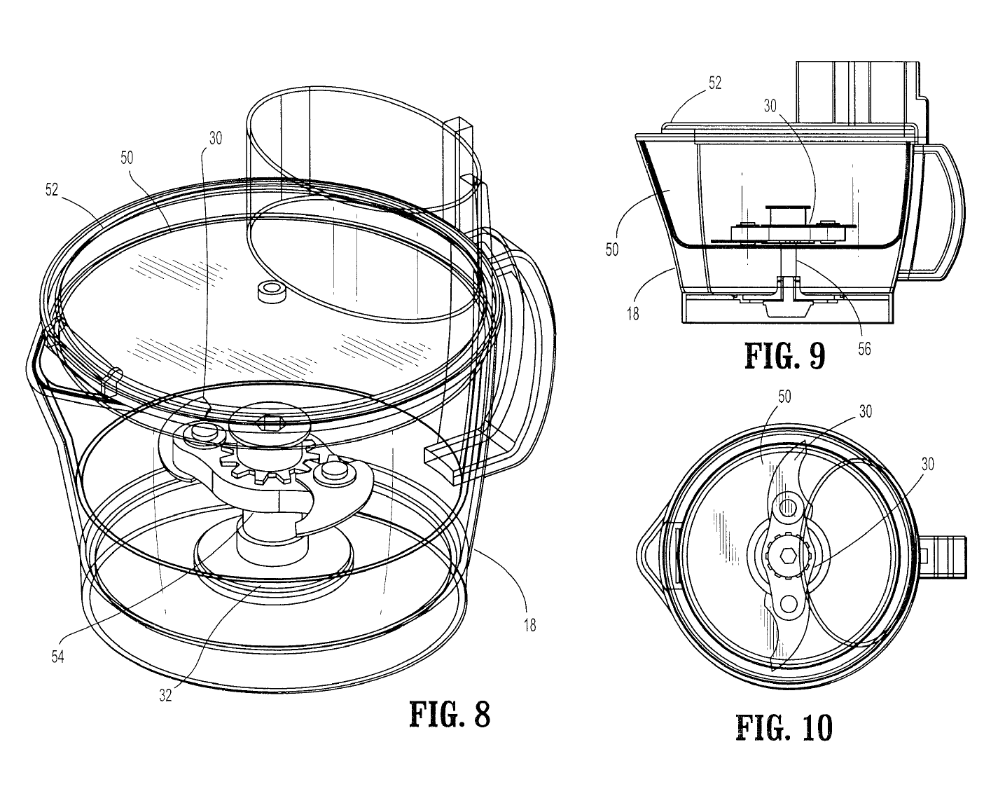

Referring now FIGS. 8-10, in another aspect of the present disclosure, main receptacle 18 incorporates a second or medium sized bowl or receptacle 50 nested within the main receptacle 18. In one arrangement, second receptacle 50 incorporates a peripheral flange 52 which is supported by the upper surface or flange of main receptacle 18. Second receptacle may accept cover 22 of main receptacle 18 or may include its own cover specifically configured for the dimensions of the second receptacle 50. Blade mechanism 30 may be mounted relative to hub 54 of second receptacle 50, e.g., about the hub shaft, to rotate with the hub 54 upon actuation of motor 14. In one embodiment, a shaft extension 56 is provided to extend between hub 32 of main receptacle 18 and hub 54 of second receptacle 50 to connect the hub 54 of the second receptacle 50 with the output of drive shaft 16 and motor 14. Shaft extension 56 may incorporate a polygonal or any non-circular cross-section to cooperate with a similar dimensioning of the respective shaft receiving opening of hub 54 of second receptacle 50. As depicted in the drawings, during operation, blades 36a, 36b may be in their first radial outward position due to the relatively enlarged dimensioning of the second receptacle 50.

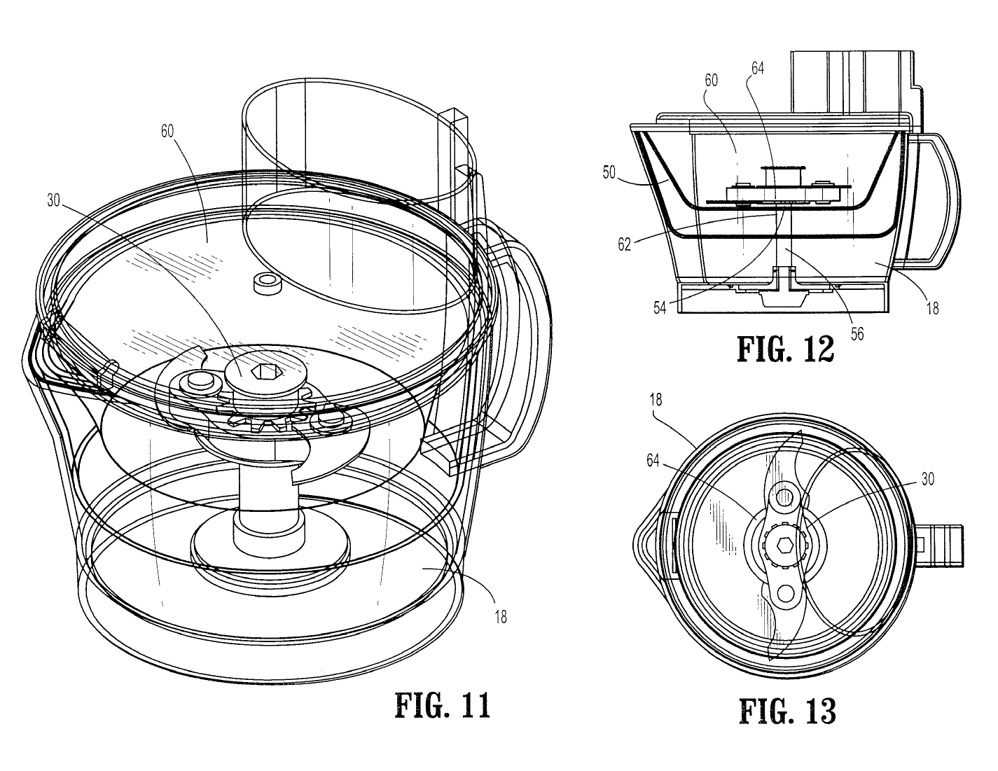

FIGS. 11-13 illustrate the addition of a third small bowl or receptacle 60 nested within second receptacle 50. Due to the relatively small dimensioning or internal diameter of third receptacle 60, the operator will move blade mechanism 30 to the second radial inward position of FIGS. 6-7 to ensure that blades 36a, 36b will be accommodated within the third receptacle 60. The transition from the first radial outward position of blades 36a, 36b to the second radial inward position of blades 36a, 36b may be effected in the aforedescribed manner. A supplemental extension shaft 62 may interconnect hub 54 of second receptacle 50 with hub 64 of third receptacle 60 to couple the output of motor 18 with blade mechanism 30.

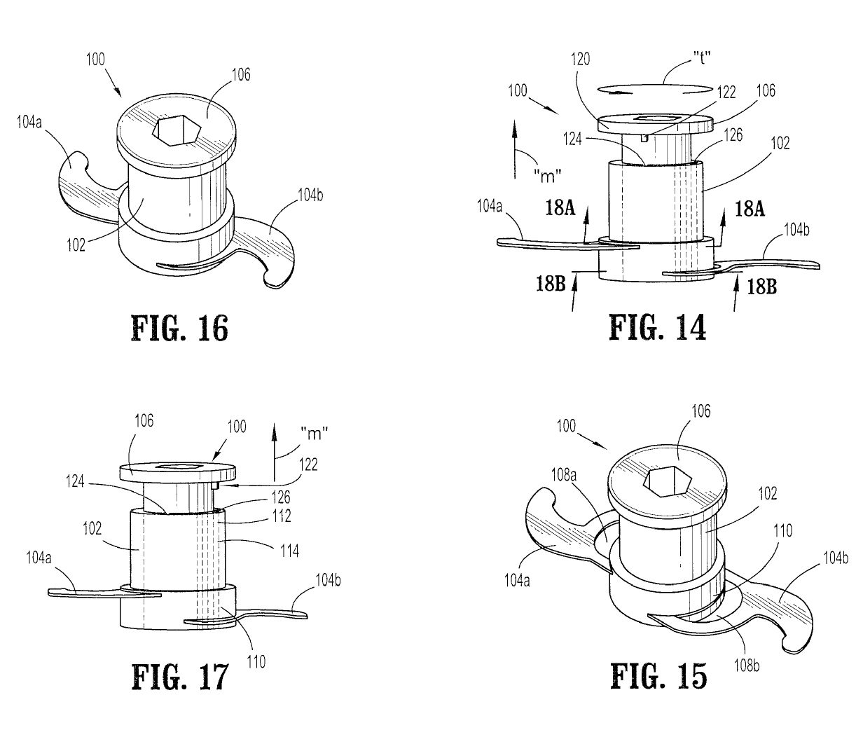

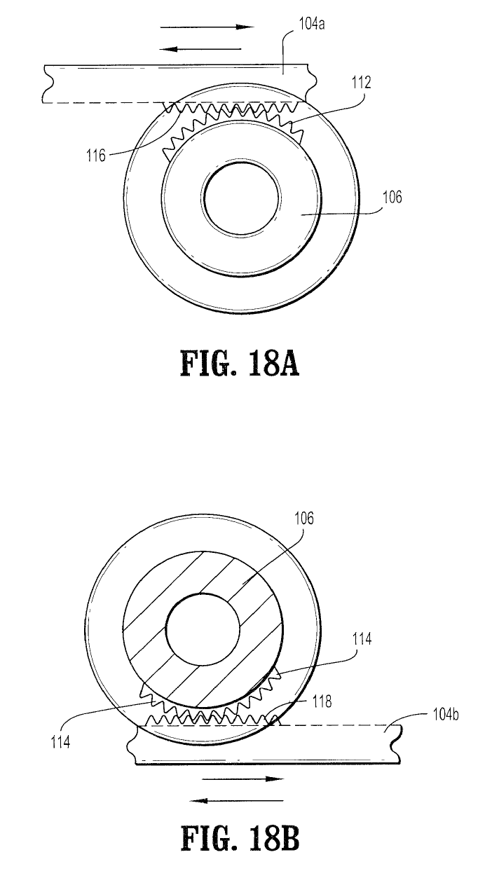

FIGS. 14-18 illustrate an alternate embodiment of the blade mechanism 30. Blade mechanism 100 incorporates central blade mount 102, a pair of blades 104a, 104b mounted to the central blade mount 102 and deployment member 106. Blades 104a, 104b define elongated openings 108a, 108b.

The peripheral reaction of blades 104a, 104b defining openings 108a, 108b may be received within grooves or channels of the blade mount. Deployment member 106 is received within blade mount 102 and is adapted for rotational movement through predetermined sectors of rotation within the blade mount 102. Respective rotational movement of deployment member 106 will move blades 104a, 104b, between the first radial outward position depicted in FIGS. 14-15 and the second radial inward position of FIGS. 16-17 for accommodation of the blades 104a, 104b within different sized receptacles or bowls as discussed hereinabove. Any means for operatively connecting blades 104a, 104b with deployment member 106 to permit movement of the blades between the outward and inward positions are envisioned including, e.g., the gear arrangement, discussed in connection with FIG. 1. In one embodiment best depicted by the cross sectional view of FIG. 17, deployment member 106 includes upper and lower external ratchet teeth arranged in opposed relation as shown. Upper ratchet teeth cooperatively engage internal ratchet teeth of blade 104a and lower teeth cooperatively engage internal ratchet teeth of blade 104b. Rotation of deployment member in a clockwise direction will cause blades 106a, 106b to extend in a radial outward direction through cooperation of the ratchet teeth of deployment member and blades 106a, 106b of FIGS. 14-15 while rotation of the deployment member in a counterclockwise direction will cause corresponding movement of the blades to the radial inward position of FIGS. 16-17.

As a further feature, deployment member 106 includes upper flange 120 having locking tab 122 depending therefrom in an axial direction. Locking tab 122 is selectively receivable within key ways 124, 126 defined within the upper surface portion of blade mount 102 to selectively secure deployment member 106 at respective positions corresponding to the radial outward and inward positions of blades 104a, 104b. In particular, when it is desired to move blade mechanism 100 to the radial inward position depicted in FIGS. 16-17, the operator may lift deployment member 106 in a vertical direction thereby (directional arrow “m”) releasing locking tab 122 from key way slot 124. The operator then rotates deployment member in the direction of directional arrow “t” to move blades 104a, 104b to the radial inward position of FIGS. 16-17. Once in this position, the operator may release or move upper flange 120 of deployment member 106 toward blade mount 102 permitting the locking tab 122 to be received within key slot 126 thereby securing blades 104a, 104b in the first radial inward position. The procedure may be reversed to move and secure blades 104a, 104b to the second radial inward position. Ratchet teeth 112, 114, 116, 118 of deployment member 106 and blades 104a, 104b may be dimensioned to permit translation of deployment member 106 relative to blades 104a, 104b.

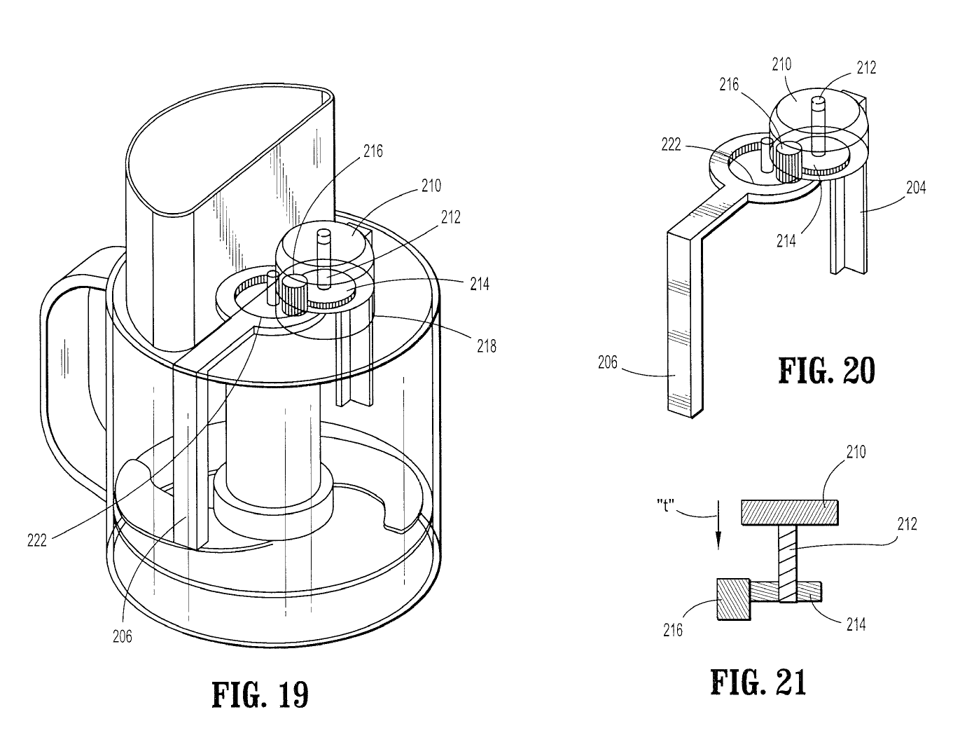

FIGS. 19-21 illustrate another aspect of the present disclosure. Food processor includes a spatula mechanism 200 to assist in scraping the side walls of enclosure or bowl 202. Spatula mechanism 200 includes a pair of scraper or spatula arms 204, 206 connected by a gear mechanism 208. Gear mechanism 208 preferably includes manual actuator 210 having central helical screw 212 depending therefrom and a plurality of interconnecting gears 214, 216 arranged in a planetary gear arrangement. In one embodiment, manual actuator 210 is mounted within or relative to an opening 218 in cover 220. Helical screw 212 attached to manual actuator 210 rotates upon depression of manual actuator 210 towards enclosure 202 in the direction of directional arrow “d” (FIG. 20) and thereby cooperatively engages first gear 214 which cooperates with second gear 216, which, in turn, cooperates with central gear section 222 of spatula arm 208 to cause at least spatula arm 206 to rotate relative to spatula arm 204. In this arrangement, spatula arms 204, 206 wipe the inside wall of the bowl 202.

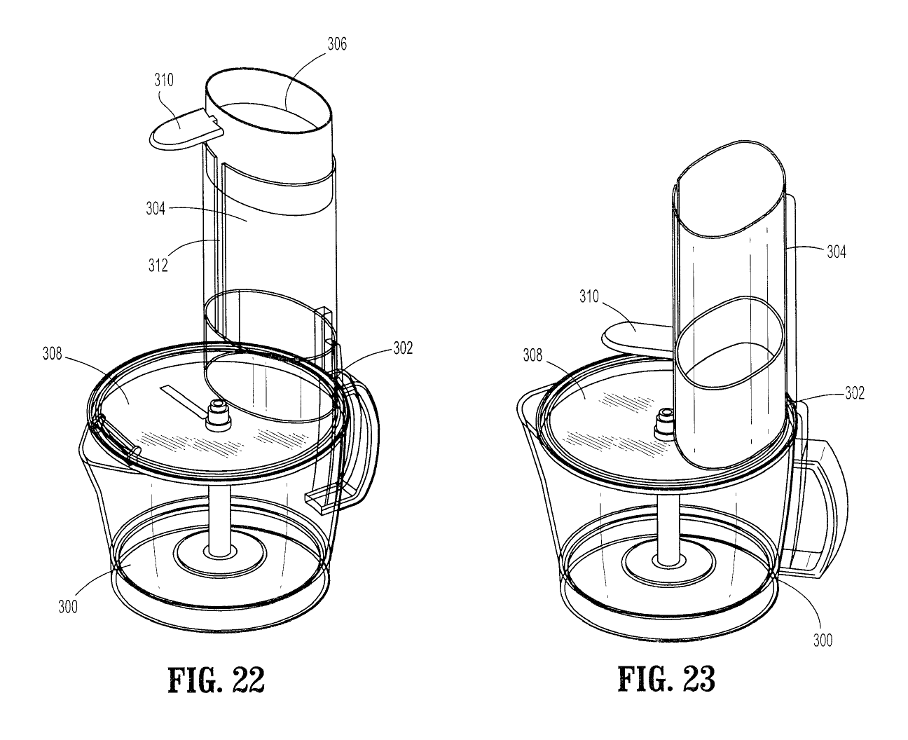

FIGS. 22-23 illustrate a food processor bowl 300 for mounting to a food processor base (not shown). Food processor bowl 30 includes a feed tube 302. Feed tube has tube extension 304 which may be selectively attached or detached from the feed tube 302. A weighted feed tube pusher 306 may be mounted at least partially within tube extension 304 and is, e.g., slidable within the tube extension 304. Pusher 306 is of sufficient weight such that under the force of gravity the pusher 306 presses food product within tube extension 304 and feed tube 302 downwardly into a rotating disc blade 308. A manual control tab 310 is provided for manual control of pusher 306, e.g., to lift the pusher 306 or to translate the pusher 306 in a downward direction. A slot 312 in the extension 304 accommodates a portion of tab 310 to permit sliding movement of the tab 310 relative to the tube extension 310.

Commonly assigned U.S. patent application entitled “Food Processor” under Attorney Docket No. 2200/p, filed on Dec. 19, 2006 U.S. provisional Ser. No. 60/875,680, and commonly assigned U.S. patent application entitled “Food Processor” under Attorney Docket No. 2202/p filed on Dec. 19, 2006 U.S. provisional Ser. No. 60/875,679 each disclose subject matter related to the present disclosure. The entire disclosures of each of these applications are hereby incorporated by reference herein.

Although the foregoing disclosure has been described in some detail by way of illustration and example, for purposes of clarity or understanding, it will be obvious that certain changes and modifications may be practiced within the scope of the appended claims.

What is claimed is:

1. A food processor, which comprises:
a base;
an enclosure mountable to the base for containing food products and defining an enclosure axis;
a drive mechanism mounted within the base;
a drive shaft connected to the drive mechanism and rotatable about a drive axis upon actuation of the drive mechanism; and
a blade mechanism mounted to the drive shaft and disposed within the enclosure, the blade mechanism including at least one blade member, the at least one black member movable between a first radial outward position relative to the drive axis and a second radial inward position relative to the drive axis.

2. The food processor according to claim 1 wherein the blade mechanism includes a pair of opposed blades, each blade movable between the first radial inward position and the second radial outward position.

3. The food processor according to claim 2 wherein the blade mechanism includes;
a blade mount to which the blades are mounted and having a shaft bore for receiving the drive shaft; and
a deployment member mounted to the blade mount and operatively connected to the blades, the deployment member movable to move the blades between the first radial inward position and the second radial outward position.

4. The food processor according to claim 3 wherein the deployment member is adapted for rotational movement to move the blades between the first radial inward position and the second radial outward position.

5. The food processor according to claim 4 wherein the blade mechanism includes at least one gear operatively connecting the deployment member and the blades whereby rotational movement of the deployment member moves the at least one gear to cause corresponding movement of the blades.

6. The food processor according to claim 4 wherein the deployment member is selectively securable at first and second rotational positions corresponding to the first radial inward position and the second radial outward position respectively of the blades.

7. The food processor according to claim 1 including a cover mountable to the enclosure.

8. The food processor according to claim 7 including a spatula mechanism mounted relative to the cover, the spatula mechanism including at least one spatula arm mounted for movement within the enclosure; and
a manual actuator for effecting movement of the at least one spatula arm.

9. The food processor according to claim 8 wherein the spatula mechanism includes a planetary gear mechanism operatively coupling the manual actuator and the at least one spatula arm.

10. The food processor according to claim 9 wherein the manual actuator is adapted for axial movement relative to the enclosure axis to actuate the planetary gear mechanism.

11. The food processor according to claim 7 wherein the cover includes a feed tube for dispensing food product within the receptacle.

12. The food processor according to claim 11 further including a feed tube extension for mounting to the feed tube and a feed tube pusher at least partially disposed within the feed tube extension.
